(19) United States
(12) Patent Application Publication
(10) Pub. No.: US 2006/0002290 A1
(43) Pub. Date: Jan. 5, 2006

(54) METHOD AND APPARATUS OF MAINTAINING A PBX SYSTEM

(76) Inventor: Heng-Chien CHEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,302

(22) Filed: Jul. 1, 2004

(51) Int. Cl. H04L 12/26

(52) U.S. Cl. 370/217

(57) ABSTRACT

A method and an apparatus of maintaining a private branch exchange (PBX) system. The PBX system has a first top-level host used for serving a plurality of IP-based PBX extensions. The method includes utilizing a first medium-level host for checking if the first top-level host is capable of serving the IP-based PBX extensions, and utilizing the first medium-level host for functioning as a second top-level host to substitute for the first top-level host if the first top-level host is unable to serve the IP-based PBX extensions.

### BACKGROUND OF INVENTION

1. Field of the Invention

The present invention relates to a method and an apparatus of maintaining a PBX system, and more particularly, to a method and an apparatus of maintaining a PBX system that utilize a backup host to periodically check the working status of the PBX host.

2. Description of the Prior Art

With the popularity of Internet connections, many IP-based applications are developed to provide users Internet connections anytime and anywhere. For example, Voice over Internet Protocol (VoIP) systems are developed to transmit voice efficiently over the Internet. An IP-based PBX system serving a plurality of IP-based extensions for transmitting VoIP packets in a PBX-like way comprises a host to control the packet traffic and store data of the PBX system. With the unstable network and host conditions, it is necessary to find a stable and efficient method of maintaining the PBX system. However, the prior art PBX system only uses a single host to maintain the packet transmission and data storage. When the host breaks down or the connection linking the host is cut off, the remote IP-based extensions can not be served, and the whole PBX system immediately fails. The original data stored in the host is also lost, and much more efforts will be made to recover the lost data and restart the PBX system.

### SUMMARY OF INVENTION

It is therefore a primary objective of the claimed invention to provide a method and an apparatus of maintaining a PBX system to solve the above-mentioned problem.

According to the claimed invention, a method of maintaining a private branch exchange (PBX) system, which has a first top-level host used for serving a plurality of IP-based PBX extensions, comprises utilizing a first medium-level host for checking if the first top-level host is capable of serving the IP-based PBX extensions, and utilizing the first medium-level host for functioning as a second top-level host to substitute for the first top-level host if the first top-level host is unable to serve the IP-based PBX extensions.

In addition, the claimed invention provides an apparatus of maintaining a private branch exchange (PBX) system. The apparatus has a first top-level host for serving a plurality of IP-based PBX extensions in the PBX system, and a first medium-level host connected to the first top-level host for checking if the first top-level host is capable of serving the IP-based PBX extensions. The first medium-level host is utilized for functioning as a second top-level host to substitute for the first top-level host if the first top-level host is unable to serve the IP-based PBX extensions.

It is an advantage of the claimed invention that the method and the related apparatus of maintaining a PBX system utilize a backup host to check the working status of the PBX host periodically. When the host breaks down or the connection linking the host is cut off, the backup host immediately substitutes for the original PBX host to serve the IP-based extensions such that the whole PBX system does not fail. The backup host periodically backups the data stored in the PBX host, so it is easy to keep the PBX system working even when the original PBX host suddenly breaks down. In addition, the backup host and the PBX host are connected through the IP sharing means in the local network such that only a physical IP address is needed to maintain the PBX host.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a PBX system according to the present invention.

FIG. 2 is a flow chart illustrating operation of a host apparatus shown in FIG. 1.

FIG. 3 is a flow chart illustrating operation of a server apparatus shown in FIG. 1.

### DETAILED DESCRIPTION

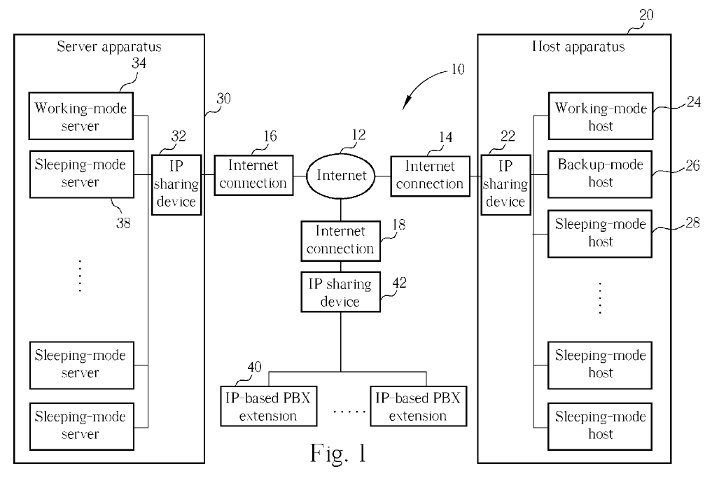

Please refer to FIG. 1. FIG. 1 is a block diagram of a PBX system 10 according to the present invention. The PBX system 10 comprises a host apparatus 20 and a server apparatus 30 for serving a plurality of IP-based PBX extensions 40, respectively. The host apparatus 20, the server apparatus 30, and the IP-based PBX extensions 40 are connected to the Internet 12 through the corresponding Internet connections 14, 16, and 18. The Internet connections 14, 16, and 18 are xDSL or other broadband connections. The host apparatus 20 comprises a working-mode host 24, a backup-mode host 26, and a plurality of sleeping-mode hosts 28. The working-mode host 24, the backup-mode host 26, and these sleeping-mode hosts 28 are connected to the Internet connection 14 through an IP sharing device 22. Concerning the server apparatus 30, it comprises a working-mode server 34 and a plurality of sleeping-mode servers 38. The working-mode server 34 and these sleeping-mode servers 38 are connected to the Internet connection 14 through an IP sharing device 32. Similarly, the IP-based PBX extensions 40 also make use of an IP sharing 42 to connect the Internet connection 14.

Both of the working-mode host 24 and the working-mode server 34 are capable of serving the IP-based PBX extensions 40. The difference between the host apparatus 20 and the server apparatus 30 is that the host apparatus 20 keeps important system data (e.g. system parameters and information of the existing IP-based PBX extensions) of the PBX system 10. However, the server apparatus 30 merely provide required VoIP data transaction. In other words, the host apparatus 20 is much more critical to the PBX system 10 than the server apparatus 30. Thus, the backup-mode host 26 is implemented within the host apparatus 20 to periodically backup system data currently stored in the working-mode host 24 in case the working-mode host 24 crashes unexpectedly.

As mentioned above, the working-mode host 24 is used to serve the IP-based PBX extensions 40 for packet traffic control and data storage, and the backup-mode host 26 periodically backups system data stored in the working-mode host 24 and checks if the working-mode host 24 is capable of serving the IP-based PBX extensions 40. If the working-mode host 24 is not capable of serving the IP-based PBX extensions 40, the backup-mode host 26 immediately takes over the host apparatus 20. That is, the backup-mode host 26 functions as a working-mode host to substitute for the crashed working-mode host 24. Thus, even the working-mode host 24 crashes or the connection linking the working-mode host 24 is cut off, the host apparatus 20 still keeps serving the IP-based PBX extensions 40. In the preferred embodiment, these sleeping-mode hosts 28 periodically check if the backup-mode host 26 functions as a working-mode host to substitute for the working-mode host 24. If the backup-mode host 26 is activated to substitute for the working-mode host 24, one of these sleeping-mode hosts 28 will function as a backup-mode host to substitute for the backup-mode host 26 to backup system data and check working status of the working-mode host 24. To sum up, there is always a working-mode host operating in the host apparatus 20 with a backup-mode host ready to take over the host apparatus 20.

Similarly, concerning the working-mode server 34, the sleeping-mode servers 38 periodically check if the working-mode server 34 is capable of serving the IP-based PBX extensions 40. If the working-mode server 34 is unable to serve the IP-based PBX extensions 40, one of these sleeping-mode servers 38 immediately functions as a working-mode server to substitute for the working-mode server 34.

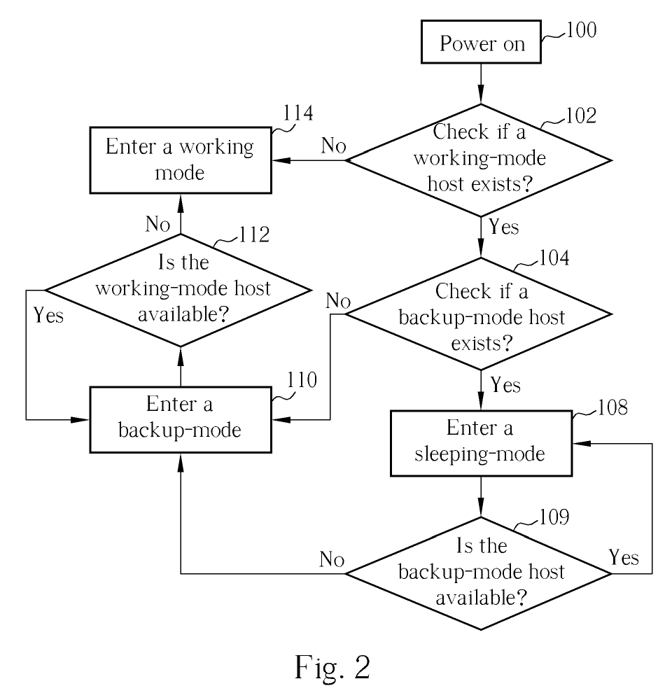

Please refer to FIG. 2. FIG. 2 is a flow chart illustrating operation of the host apparatus 20 shown in FIG. 1. The operation includes the following steps:
Step 100: Power on a host of the host apparatus 20;
Step 102: The host checks if there is a working-mode host 24 existing in the host apparatus 20 for serving the IP-based PBX extensions 40. If the working-mode host 24 exists, go to step 104; otherwise, go to step 114;
Step 104: The host checks if there is a backup-mode host 26 existing in the host apparatus 20. If the backup-mode host 26 exists, go to step 108; otherwise, go to step 110;
Step 108: The host enters a sleep-mode to function as a sleeping-mode host 28;
Step 109: Is the backup-mode host 26 available to the host? If yes, the host periodically performs step 109; otherwise, go to step 110;
Step 110: The host enters a backup-mode to function as a backup-mode host 26;
Step 112: Is the working-mode host 24 available to the host? If yes, the host periodically performs step 112; otherwise, go to step 106; and
Step 114: The host enters a working-mode to function as a working-mode host 24.

After a host of the host apparatus 20 is powered on, the activated host first acknowledges the working status of the working-mode host 24 by two ways (steps 100 and 102). One way is that the working-mode host 24 outputs a survival packet to inform the host about the existing working-mode host 24. That is, if the working-mode host 24 is capable of serving the IP-based PBX extensions 40, the newly activated host will receive the survival packet from the working-mode host 24. Another way is that the host outputs a query packet to the working-mode host 24. Therefore, if the working-mode host 24 is capable of serving the IP-based PBX extensions 40, the working-mode host 24 will return an acknowledgement packet corresponding to the query packet to inform the host. In other words, if the working-mode host 24 works normally, the newly activated host will receive the acknowledgement packet from the working-mode host 24. If the checking result shows that no working-mode host is available within the host apparatus 20, the host will enter a working-mode to function as a required working-mode host 24 (step 114). However, if the host finds out that there is a working-mode host 24 functioning normally within the host apparatus 20, the host will check if there is an available backup-mode host 26 by the same two ways mentioned above (step 104). If the checking result shows that no backup-mode host is available within the host apparatus 20, the host will enter a backup-mode to function as a required backup-mode host 26 (step 110). However, if the host finds out that there is a backup-mode host 24 functioning normally within the host apparatus 20, the host will enter a sleeping-mode to function as a sleeping-mode host 28 (step 108).

After the host becomes the sleeping-mode host 28, the host starts checking the working status of the backup-mode host 26 periodically (step 109). That is, if the backup-mode host 26 works normally, the host will check the backup-mode host 26 again after a predetermined period. Once the host detects that no available backup-mode host 26 is existing in the host apparatus 20, the host being the sleeping-mode host 28 enters the backup-mode to substitute for the crashed backup-mode host 26 immediately (step 110).

After the host becomes the backup-mode host 28, the host starts checking the working status of the working-mode host 24 periodically (step 112). In other words, if the working-mode host 24 works normally, the host will check the working-mode host 24 again after a predetermined period. Please note that when the host acts as the backup-mode host 28, it will backup system data (e.g. system parameters and information of the IP-based PBX extensions 40) of the currently running working-mode host 24 periodically. Once the host detects that no available working-mode host 24 exists in the host apparatus 20, the host being the back-mode host 26 enters the working-mode to substitute for the crashed working-mode host 24 immediately (step 114). Please note that the above-mentioned two ways disclosed for steps 102 and 104 can be utilized in steps 109 and 112 to perform the checking operation.

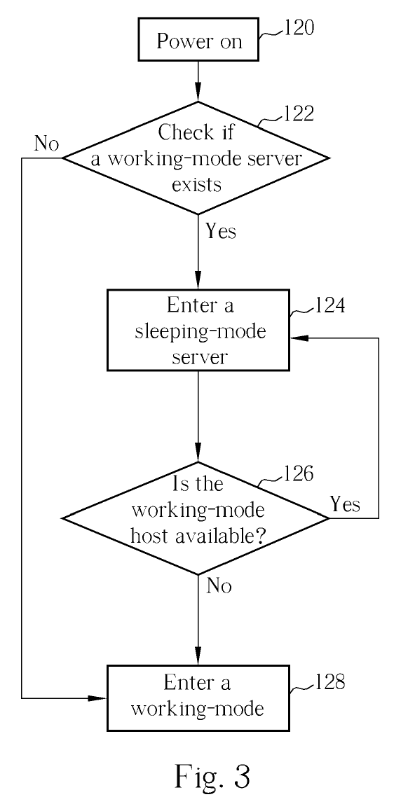

Please refer to FIG. 3. FIG. 3 is a flow chart illustrating operation of the server apparatus 30 shown in FIG. 1. The operation includes the following steps:
Step 120: Power on a server of the server apparatus 30;
Step 122: The server checks if there is a working-mode server 34 existing in the server apparatus 30 for serving the IP-based PBX extensions 40. If the working-mode server 34 exists, go to step 128; otherwise, go to step 124;
Step 124: The server enters a sleeping-mode to function as a sleeping-mode server 38;
Step 126: Is the working-mode server 34 available? If yes, the server periodically performs step 126; otherwise, go to step 128; and
Step 128: The server enters a working-mode to function as a working-mode server 34.

After a server of the server apparatus 30 is powered on, the activated server acknowledges the working status of the working-mode server 34 by two ways (steps 120 and 122). One way is that the working-mode server 34 outputs a survival packet to inform the server about the existing working-mode server 34. Another way is that the server outputs a query packet to the working-mode server 34 for asking for an acknowledgement packet. If the checking result shows that no working-mode server 34 is available in the server apparatus 30, the server will enter a working-mode to function as a required working-mode server 34 (step 128). However, if the server finds out that there is a working-mode server 34 functioning normally within the server apparatus 20, the server will enter a sleeping-mode to function as a sleeping-mode host 38 (step 124).

After the host becomes the sleeping-mode server 38, the server starts checking the working status of the working-mode server 34 periodically (step 126). That is, if the working-mode server 34 works normally, the server will check the working-mode server 34 again after a predetermined period. Once the host detects that no available working-mode server 34 is existing in the server apparatus 30, the host being the sleeping-mode server 38 enters the working-mode to substitute for the crashed working-mode server 34 immediately (step 128). Please note that the above-mentioned two ways disclosed for step 122 can be utilized in step 126 to perform the checking operation.

In contrast to the prior art, the method and apparatus of maintaining a PBX system according to the present invention utilize a backup host to check the working status of the PBX host periodically. When the host breaks down or the connection linking the PBX host and the backup host is cut off, the backup host immediately substitutes for the PBX host to serve the IP-based extensions such that the whole PBX system does not fail. The backup host periodically backups the data stored in the PBX host, so the PBX system keeps working even the PBX host suddenly breaks down. In addition, the backup host and the PBX host are connected through the IP sharing device in the local network. Therefore, only a physical IP address is needed to maintain the PBX host.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A method of maintaining a private branch exchange (PBX) system, the PBX system comprising a first top-level host, the first top-level host being used for serving a plurality of IP-based PBX extensions, the method comprising:
utilizing a first medium-level host for checking if the first top-level host is capable of serving the IP-based PBX extensions; and
utilizing the first medium-level host for functioning as a second top-level host to substitute for the first top-level host if the first top-level host is unable to serve the IP-based PBX extensions.

2. The method of claim 1 further comprising:
utilizing a bottom-level host for checking if the first medium-level host functions as the second top-level host; and
utilizing the bottom-level host for functioning as a second medium-level host to substitute for the first medium-level host if the first medium-level host functions as the second top-level host.

3. The method of claim 2 wherein the first top-level host, first medium-level host, and the bottom-level host are connected to the Internet through an IP-sharing.

4. The method of claim 2 wherein the first medium-level host periodically outputs a survival packet to inform the bottom-level host that the first medium-level host does not function as the second top-level host yet.

5. The method of claim 2 wherein the bottom-level host periodically outputs a query packet to the first medium-level host, and the first medium-level host returns an acknowledge packet corresponding to the query packet to inform the bottom-level host that the first medium-level host does not function as the second top-level host yet.

6. The method of claim 2 further comprising:
utilizing the first medium-level host to periodically backup data stored in the first top-level host when the first top-level host is capable of serving the IP-based PBX extensions; and
utilizing the second medium-level host to periodically backup data stored in the second top-level host when the first medium-level host functions as the second top-level host.

7. The method of claim 1 wherein the first top-level host periodically outputs a survival packet to inform the first medium-level host that the first top-level host is capable of serving the IP-based PBX extensions.

8. The method of claim 1 wherein the first medium-level host periodically outputs a query packet to the first top-level host, and the first top-level host returns an acknowledge packet corresponding to the query packet to inform the first medium-level host that the first top-level host is capable of serving the IP-based PBX extensions.

9. The method of claim 1 wherein the first top-level host and first medium-level host are connected to the Internet through an IP-sharing.

10. An apparatus of maintaining a private branch exchange (PBX) system, comprising:
a first top-level host for serving a plurality of IP-based PBX extensions in the PBX system; and
a first medium-level host connected to the first top-level host for checking if the first top-level host is capable of serving the IP-based PBX extensions, utilizing the first medium-level host for functioning as a second top-level host to substitute for the first top-level host if the first top-level host is unable to serve the IP-based PBX extensions.

11. The apparatus of claim 10 further comprising:
a bottom-level host connected to the first medium-level host for checking if the first medium-level host functions as the second top-level host, utilizing the bottom-level host for functioning as a second medium-level host to substitute for the first medium-level host if the first medium-level host functions as the second top-level host.

12. The apparatus of claim 11 wherein the first top-level host, first medium-level host, and the bottom-level host are connected to the Internet through an IP-sharing.

13. The apparatus of claim 11 wherein the first medium-level host periodically outputs a survival packet to inform the bottom-level host that the first medium-level host does not function as the second top-level host yet.

14. The apparatus of claim 11 wherein the bottom-level host periodically outputs a query packet to the first medium-level host, and the first medium-level host returns an acknowledge packet corresponding to the query packet to inform the bottom-level host that the first medium-level host does not function as the second top-level host yet.

15. The apparatus of claim 11 wherein the first medium-level host periodically backups data stored in the first top-level host when the first top-level host is capable of serving the IP-based PBX extensions, and the second medium-level host periodically backups data stored in the second top-level host when the first medium-level host functions as the second top-level host.

16. The apparatus of claim 10 wherein the first top-level host periodically outputs a survival packet to inform the first medium-level host that the first top-level host is capable of serving the IP-based PBX extensions.

17. The apparatus of claim 10 wherein the first medium-level host periodically outputs a query packet to the first top-level host, and the first top-level host returns an acknowledge packet corresponding to the query packet to inform the first medium-level host that the first top-level host is capable of serving the IP-based PBX extensions.

18. The apparatus of claim 10 wherein the first top-level host and first medium-level host are connected to the Internet through an IP-sharing.
